(19) United States
(12) Patent Application Publication
(10) Pub. No.: US 2013/0282589 A1
(43) Pub. Date: Oct. 24, 2013

(54) MULTI-FACTOR MOBILE TRANSACTION AUTHENTICATION

(71) Applicant: CONDUCTIV SOFTWARE, INC, Woodinville, WA (US)

(72) Inventors: David L. Shoup, Woodinville, WA (US); Robert O'Farrell, Woodinville, WA (US)

(73) Assignee: Conductiv Software, Inc., Woodinville, WA (US)

(21) Appl. No.: 13/867,833

(22) Filed: Apr. 22, 2013

Related U.S. Application Data
(60) Provisional application No. 61/636,550, filed on Apr. 20, 2012.

(51) Int. Cl. G06F 21/34

(52) U.S. Cl. CPC G06F 21/34; G06Q 20/382
USPC 705/67; 726/5

(57) ABSTRACT

Disclosed are authentication systems and techniques that can automatically recognize, validate, and utilize different types of information including user information, device information, and network information. Each of these types of information is processed with a unique algorithm and then is encrypted for security purposes. The processed and encrypted information are then used as components of a multi-factor authentication process. During an actual authentication transaction, these unique identifiers are used along with real-time personal identification methods including, but not limited to, biometrics and/or a personal identification number (the “PIN”), to complete the authentication process between two devices. A backend server communicates to both the devices to create a highly secure closed-loop authentication process. This authentication process can be used to interface with other processes or systems to enable customer identification, payment processing or any other business process that can benefit from a secure, positive identification authentication capability.

### PRIORITY

This application claims priority to U.S. Provisional Application Ser. No. 61/636,550 filed Apr. 20, 2012 under named inventors David L. Shoup and Robert O'Farrell, and entitled “Multi-Factor Mobile Transaction Authentication”, which is referred to and incorporated herein by reference in its entirety.

### BACKGROUND

“Authentication” may be defined as any protocol or process that permits one entity to establish the identity of another entity. Living creatures have been performing authentication at some level for all of history. The traditional methods of authentication are based on the realities of our physical world; basic human authentication is achieved by identifying unique physical characteristics of other human beings. Humans most commonly use facial recognition or voice recognition to identify others, but may also use general appearance or demeanor, such as style of dress, or body language, or actions in face-to-face situations. In the case of human interactions and transactions that are accomplished face-to-face, these methods are usually reliable, or at least, reliable enough for the purposes of most individuals. In situations that are not face-to-face, people typically use other methods, such as basic handwriting recognition or stylistic recognition (for example, a person's writing or painting style) to authenticate a person, their possessions, or their work.

In general, humans have used authentication, and throughout history, they have used three methods. These methods may be summarized as: (1) Something you know (e.g. a password); (2) Something you have (e.g. an official's ring or seal); and (3) Something you are (e.g. your face, your voice, your fingerprints, or your DNA). Today, these methods are called the three factors of authentication. The International Information Systems Security Certification Consortium, Inc., also referred to as (ISC)2 or ISC2, also adds a fourth category called “Someplace you are”, which is based on your geographic location and which typically uses GPS (global positioning system) data to determine location.

How Do We Use These Factors in Computer Authentication?

Passwords

Most commonly, computers use passwords, the “something you know” factor above, for basic authentication. In the early days of computing, computers were complicated and largely unknown, which meant they were expensive to buy and expensive to operate. Ownership was not widespread. In such a situation, a computer's owner allowed others to use his computer, but often demanded a large fee to offset the cost of running the system. Also, there tended to be many users of the computer system, and the users liked keeping control over their own data and programs available for their own use. To provide proper accounting for better system resource charge-back and to provide basic security for individual users' data, administrators began using usernames along with passwords, so that users could be tracked individually for authorization and accounting purposes.

Passwords are the simplest authentication model to implement, and that is generally why password models are so common. Unfortunately, password models are also one of the weakest authentication models, because passwords may be guessed or stolen relatively easily. Users often choose weak passwords; an example of a hypothetical person named “Joe” illustrates this. The person “Joe” doesn't want to be burdened with creating and maintaining a relatively secure password; he simply wants to log in and do his work. So, he has the username “joe” and he creates the password “joe” (or “joe1”) for his account. This sort of password weakness, being so common and easily guessed, makes any password model vulnerable. The system administrator can take measures to mitigate the threat of “joe” accounts. For example, the administrator could implement a minimum password length, such as eight characters, for a password to be accepted by the system. The administrator could enforce basic password complexity, which would evaluate a new password against specific criteria such as using at least one letter, one number, and one special character (!, @, #, $, %, ̂), and so on. The administrator could force password changes at particular time intervals, so that a stolen or guessed password is assured of no longer being usable after the particular period of time. The administrator could also employ a password history check that would prevent the same passwords from being used over and over by any individual user. However, these measures can force users to write passwords down, which limits the value of the password because a password left out, in writing, can be more easily stolen.

Tokens

Some authentication systems commonly use tokens, which comprise any device or object that can authenticate a user. In the previous example above, we referred to the general's ring or seal. These are traditional examples of tokens.

Common modern examples of tokens include physical keys, proximity cards, credit cards, and ATM cards. Tokens are desired because they are simple to use. Physical keys, for example, are widely supported and cheap to produce and use. In computer authentication, cryptographic keys may be used, particularly in remote protocols such as SSH (secure shell). The advantage of cryptographic keys for remote protocols is that they may not only be used for user authentication, but also for message authentication and encryption of data in transit.

Tokens have their own weaknesses, however. Because tokens are simple and cheap to produce, they are also simple and cheap to reproduce. This makes them vulnerable to being counterfeited. Also, because they are typically a physical object or device, they can be stolen more easily than passwords. For this reason, tokens are typically used in conjunction with another method, such as a PIN code, to reduce the usefulness of a stolen token.

Biometrics

Discussed above was the way in which authentication focuses on unique identifying characteristics to ensure proper identification. Humans have specific physical attributes that are unique to specific individuals. Humans are conditioned to recognize these characteristics and use them for authentication. However, it is more difficult for computers, which “think” in digital ones and zeros, to recognize “analog” characteristics such as faces or voices. However, in recent years, technology has made sufficient leaps to allow computer systems to process these characteristics. We call the systems that do this type of authentication processing “biometric” systems.

Biometric systems come in many varieties, with each variety measuring a physical characteristic found to be relatively unique to a specific individual, within a reasonable scale of individuals. A user enrolls in a biometric system by providing a sample of the physical characteristic measured by the system. The system then converts this “analog” characteristic into digital form to create a template. The template is then stored on a central authentication server. The user authenticates to the system by providing a fresh sample of the characteristic to the system, which then compares the digitized fresh sample to the stored template. If the two digitized samples are similar within certain tolerances, the user is accepted. There are many examples of biometric characteristics suitable for authentication. Common biometric systems include the following:
Facial recognition—Measures distances between specific points on the face.
Fingerprints—Measures distances between specific points on a fingerprint.
Hand geometry—Measures the length of fingers and the length and width of the hand.
Keystroke dynamics—Measures specific keystrokes in typing a predetermined phrase; this is commonly used with existing password systems.
Hand vein—Reads the venal and arterial patterns within a human hand.
Iris—Measures the color and pattern of the iris in the eye.
Retina—Reads the venal and arterial pattern on the retina of the eye.
Signature—Recognizes the signature as well as the speed and style of the actual performance of writing the signature.
Voice—Measures and recognizes specific audio patterns in human speech for predetermined phrases.
Facial thermogram—Recognizes heat patterns in the face using a thermal camera.
DNA—Measures the specific patterns of genes in human DNA.

These biometric techniques above have varying degrees of accuracy, but all have been proven as relatively accurate and usable, particularly at the scale that most organizations require. When comparing the measured characteristics of a few hundred or even a few thousand people, rather than a few million, these characteristics provide reasonable, measurable uniqueness in the tolerance levels of each system.

Centralized Authentication Systems

Another challenge for proper computer authentication came as computer systems moved from the big mainframes that characterized early computing in large research, military, and corporate organizations, to the more flexible client-server model that distributed computing power to many physical and logical locations within those organizations. After users were able to move around among large numbers of systems, authenticating those users consistently became a greater challenge. Administering local system accounts became impractical as the number of users and systems increased. Developers and administrators moved to a centralized authentication model, which uses a central authority system that can remotely authenticate users across large numbers of systems. Many different systems and protocols were developed for this purpose: remote-authentication protocols such as RADIUS (Remote Access Dial-In User Service), TACACS (Terminal Access Controller Access-Control System), Kerberos, and DIAMETER; and directory-based systems such as Novell's NDS (Novell Directory Services), Microsoft's Windows NT domains, and later, Active Directory.

Multi-Factor Authentication

We have already discussed the three factors of authentication. Any single factor has its strengths and weaknesses. However, we can increase the reliability and security of the authentication mechanism by combining multiple authentication factors into a single model. For example, ATM cards, as tokens, have their authentication strength increased when they are used by combining them with a PIN number. The two factors together provide a much higher confidence in the authentication. Tokens are commonly combined with passwords or PINS in a special way to create one-time passwords for use in authenticating to computer systems. In the authentication system “SecurID” available from RSA, for example, the user carries a token that is time-synchronized to the RSA central authority server. The token generates a six-digit number that changes every 60 seconds. To log in, the user combines the six-digit number displayed on the token with her personal PIN to create the one-time password for that login session. The token authentication system by ActivCard requires the user to enter her PIN into the token, which uses a special algorithm to generate the one-time password for the user to enter. Secure Computing's SafeWord system uses a counter-based token, which simply provides a specific six character hexadecimal string for the user to enter as a password. Other tokens utilize a software token, which can be carried on a separate system, such as a PDA or cell phone, and generate a password string.

Some tokens use a challenge-based system. In this type of system, when the user attempts to authenticate, the central server issues a challenge to the user. The user enters the challenge into the token, which runs a special algorithm to generate a password string. This is similar to the ActivCard system, except that a different challenge is used every time a log-in is attempted, and is entered into the token rather than the user's PIN.

Finally, smartcards are another token-based, multi-factor authentication system. The smartcard stores a cryptographic key on the card, which is unlocked by the user using a special keypair. When the user authenticates, he puts his smartcard into a special reader attached to the system to which he is trying to log in. The system reads the key from the smartcard and asks the user for his passphrase to unlock the key. After the user enters the passphrase, the system performs a cryptographic key exchange with the central server for verification of the key. If the key is verified, the user is authenticated.

Multi-factor authentication techniques are not limited to tokens and passwords. Many high-security biometric systems will combine the biometric sample with a password or token. In very high-security applications, all three factors are used. This scenario is commonly seen by the general public in movies such as Mission: Impossible; in that movie, there is a scene in which users enter a high-security room by providing a voiceprint sample, then enter a PIN, and then use an access card and provide a retina scan. Then and only then are they permitted to enter the MOM.

Split Authentication

For the ultra-high-security applications, simply authenticating one user directly against the central authority is not enough, even if all three factors are used. These situations may require authentication to be split among multiple entities, so that the high level of privilege granted by the authentication credential is not abused by a single party. For example, control of nuclear missile launch systems is typically handled by split authentication. It is too much for a single individual to hold control over the launch of a nuclear missile; should that individual decide to launch the missile without orders, there is no process or capability to prevent the launch. As a result, the authentication for the launch system is split between at least two individuals. Both individuals have to enter their part of the authentication for the launch to be authorized. In some cases, the authentications must take place simultaneously. In the missile example, the two individuals might have physical keys, which they insert into a keyhole and turn simultaneously to authorize the missile launch. Safe deposit boxes at banks use a similar system; the box lessee is authenticated by a bank employee, who inserts her key into the box. The lessee then inserts his own key in the box, and only then is the box opened.

Split authentication is accomplished in the computer world by splitting passwords or cryptographic keys among multiple parties. Many public-key protocols and systems, such as “PGP”, permit splitting keys among multiple parties, so that messages may be encrypted, decrypted, or signed only when all parties submit their individual part of the split key. A simple split authentication system for super-user access would have two administrators create half of a password. They each type in their part of the password individually, to set the password for the super-user account. They then write down their half, seal it in an envelope, and mark the envelope as the first or second half of the password. They then place the envelopes in a secure safe. Because neither administrator (and no other administrators of the system) knows the full super-user password, neither administrator may use the super-user password unless the other agrees and enters their password half. The whole password is recoverable from the safe in an emergency or if either administrator should leave the company.

Message Authentication

It isn't always a user who must be authenticated in the computer world. Sometimes, a message must be authenticated, or at least verified that it has not been altered in transit. This is known as integrity. In this case, a message authentication code (MAC) may be used. A MAC is generated by combining the message with a secret key shared by both the sender and receiver of the message. When he creates a message for transmission, the sender generates a MAC and attaches it to the message. When the receiver receives the message, she recalculates the MAC with the same secret key, then checks her calculated MAC against the MAC attached to the message. If they match, she knows the message has not been altered.

What happens if the message not only needs to be checked for tampering, but also needs to be verified because of the purported sender who actually sent the message? What if the sender later tries to claim that he never sent the message? This technique provides authenticity and non-repudiation, and to accomplish this, it is necessary to use digital signatures, which are a benefit of using a public-key cryptosystem such as PGP. The sender generates a hash from the message using a standard hash algorithm. He then encrypts the hash with his private encryption key and attaches the encrypted hash to the message. The receiver receives the message and encrypted hash. She then decrypts the hash with the sender's public encryption key and recalculates the hash from the received message. If her calculated hash matches the hash decrypted from the message, she can be certain that the message was not altered and that it definitely came from the sender.

Summary of Conventional Authentication

Authentication is any protocol or process that permits one entity to establish the identity of another entity. It relies on three factors: (1) Something a user knows, such as a password or PIN; (2) Something a user has, such as a key, a card, or another kind of token; and (3) Something a user is, such as a retina scan, fingerprint, or voiceprint.

These factors have their own strengths and weaknesses, but they may be combined to increase the security of the authentication procedure. For ultra-high-security applications, authentication may be split among multiple parties. It's not only a user who is authenticated; messages are, too. Messages may be authenticated for integrity to ensure they have not been altered in transit and for authenticity and non-repudiation, so that the sender may be verified and may not later claim he never sent the message. We may use message authentication codes for integrity, and we may use digital signatures for integrity, authenticity, and non-repudiation.

Mobile payment processing places a premium on convenience and efficiency; it requires the ability to have a lowest common denominator process that ensures security while providing an effective and convenient user experience. Utilizing device-to-device interfaces such as infra-red, Bluetooth, WiFi, optical, and near-field communications enable transactions to occur, yet each has their issues. Improved authentication systems should provide convenience and efficiency, along with reliability and security.

### SUMMARY

Disclosed herein are authentication systems and techniques that can automatically recognize, validate, and utilize different types of information including user information, device information, and network information. Each of these types of information is processed with a unique algorithm and then is encrypted for security purposes. The processed and encrypted information is then used as one or more components of a multi-factor authentication process. During an actual authentication transaction, these unique identifiers are used along with real-time personal identification methods including, but not limited to, biometrics and/or a personal identification number (the “PIN”), to complete the authentication process between two devices. A backend server communicates to both the devices to create a highly secure closed-loop authentication process. This authentication process can be used to interface with other processes or systems to enable customer identification, payment processing or any other business process that can benefit from a secure, positive identification authentication capability.

### BRIEF DESCRIPTION OF THE DRAWINGS

FIG. 1 is a flow diagram that shows operations involving user entry, creation, and registration of the application key, correlation with the user identification information, and storage of user-specific information into the User ID Register.

FIG. 2 is a flow diagram that illustrates operations for the generation, storage, and replenishment of Authentication Keys in the User and Server Application.

FIG. 3 is a flow diagram that illustrates operations for the utilization of keys directly in the Server Application and through the Merchant Application.

FIG. 4 is a flow diagram that illustrates operations for an interface with an external system for final payment authorization.

FIG. 5 is a flow diagram that illustrates operations for location proximity management involved in determining whether the Server Application should require geographic location as a factor in the authentication of a transaction.

FIG. 6 is a block diagram of a computer device suitable for performing the operations of FIGS. 1 through FIG. 5.

### DETAILED DESCRIPTION

In-person mobile payment processing in a retail establishment requires the ability to have a lowest common denominator process that ensures security while providing an effective user experience. Utilizing device-to-device interfaces like infra-red, Bluetooth, WiFi, optical and near-field communications enable transactions to occur yet each has their issues. This invention involves the ability to automatically recognize, validate and utilize different types of information including user information, device information and network information including, but not limited to user name, password, mobile phone number, IMEI, and IMSI. As described further below, the device information may be obtained from an application key that is stored at the device.

Each of these three types of information is selectively run through a proprietary algorithm and then is encrypted for security purposes. They are then used as components of a multi-factor authentication process. During an actual authentication transaction, these unique identifiers are used along with real-time personal identification methods including, but not limited to biometrics and/or personal identification number (the “PIN”) and/or location, to complete the authentication process between two devices. A backend server communicates to both the devices to create a highly secure closed-loop authentication process. This authentication process can be used to interface with other processes or systems to enable customer identification, payment processing or any other business process that can benefit from a secure, positive identification authentication capability.

For example, in the case of a customer processing a purchase with a retail store, each party must trigger the payment process on their respective side of the transaction and then communicate the proprietary key or token between their respective devices using one of many supported methods including, but not limited to screen-to-camera (optical) or radio interface (e.g., NFC, Bluetooth, peer-to-peer WiFi). Upon the completion of this communication, the system may require another factor of authentication, either physical, like entering a PIN or virtual, like determining the proximity of the two devices using location-based services. Once the transaction is fully authenticated using the factors determined as required to ensure the highest level of surety, the transaction is authenticated and communicated to another system for action (e.g., payment processing).

The features noted above are described further with reference to the discussion below and accompanying diagrams.

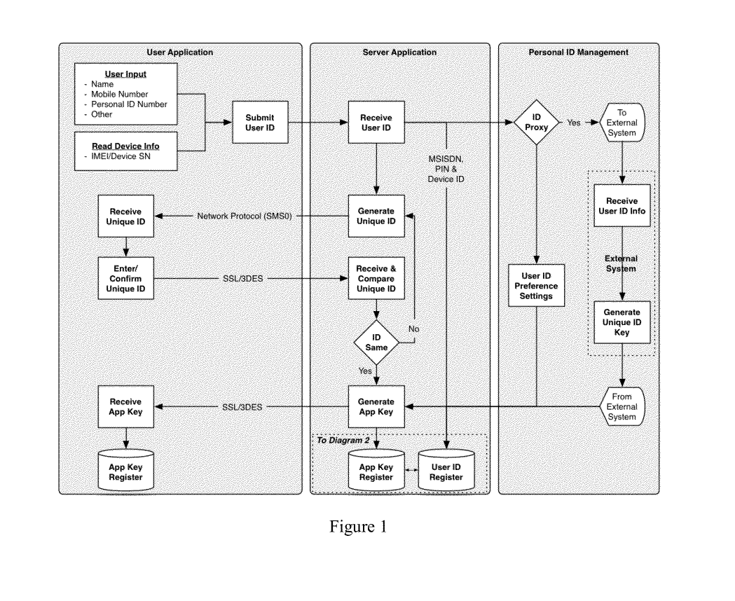

FIG. 1

FIG. 1 shows user entry, creation, and registration of the application key (“App Key”), correlation with the user identification information (“User ID”), and storage of user-specific information into the User ID Register. The operations performed involve the following sequence, as depicted in FIG. 1.
1. User enters registration information and submits the information.
2. The Server Application receives this information and (1) generates a unique ID for transmission back to the device indicate by the entered mobile number and (2) sends the personal ID information to an external system to correlate the user to that system.
3. The User Application either transmits the unique ID back to the Server Application or displays the ID for the user to enter into an appropriate entry field for transmission back to the Server Application where it is confirmed.
4. The Server Application then generates and transmits the Application Key to the User Application for secure storage and stores it in its own database for future use in the authentication process.

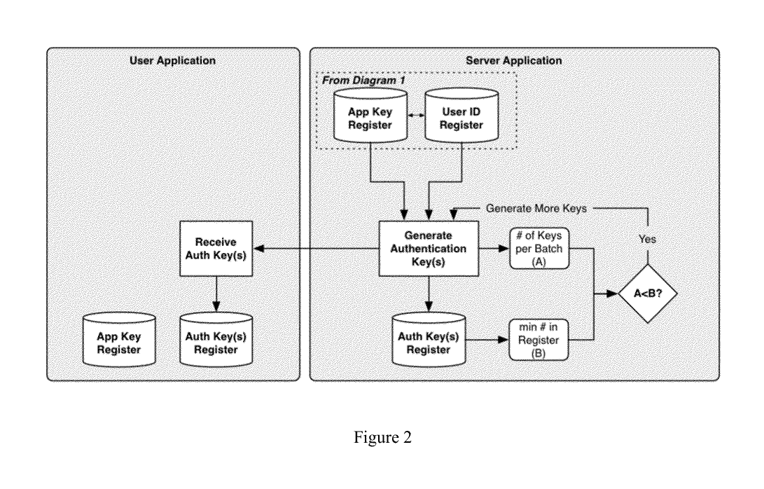

FIG. 2 (Continuation of Processing Operations of FIG. 1)

FIG. 2 illustrates the generation, storage, and replenishment of Authentication Keys in the User and Server Application, in a continuation of processing that was initiated in the FIG. 1 operations. The continuation is indicated in FIG. 2 at the Server Application.
1. Upon receiving and storing the Application Key, the Server Application uses the Application Key and select User information to generate a batch of Authentication Keys, the quantity which is based on preference settings. The Server Applications then stores this batch in its Authentication Key Register.
2. The Authentication Keys are securely transmitted to the User Application where they are stored in an encrypted Authentication Key register.
3. The Server Application monitors the number of Authentication Keys in the Authentication Key Register. If the number of keys is less than a value set in a preference file, the Server Application will generate an additional batch of Authentication Keys.

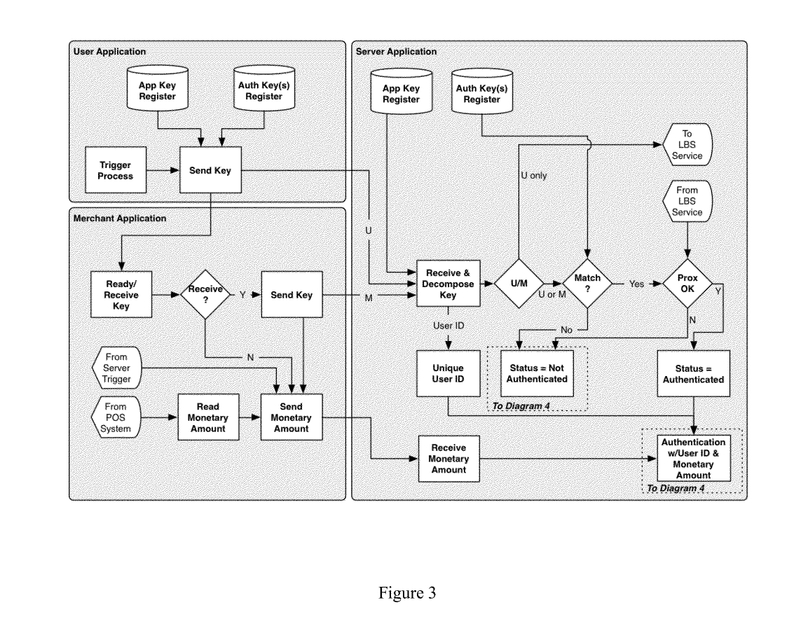

FIG. 3

FIG. 3 illustrates the utilization of keys directly in the Server Application and through the Merchant Application. The following operation sequence is illustrated in FIG. 3.
1. The utilization of an Authentication Key is triggered via an application process in the User Application. This process may be triggered manually or automatically.
2. The User Application selects an Authentication Key from the Authentication Key Register, combines it with the Application Key from the Application Key Register and then securely transmits it to the Server Application
3. If a Merchant Application is available, the composed key is also transmitted via device-to-device transponders to the Merchant Application. Once received, the Merchant Application retransmits this key to the Server Application. The Merchant Application receives a monetary amount either from an entry field or third-party commerce application and sends this amount simultaneously to the Server Application
4. The Server Application manages one of two scenarios:
   a. User key is received alone: the Server application decomposes the transmitted key and then checks the Authentication Key for a match in its own Authentication Key Register. If there is a match the Server Application checks for location proximity. If both are okay, the transaction is authenticated. If one or the other is not okay, the transaction is not authenticated
   b. User and merchant key are both received: the Server application decomposes the transmitted key from the Merchant Application and then checks the Authentication Key for a match in its own Authentication Key Register. If there is a match the transaction is authenticated without checking proximity.
5. If the transaction is authentication, the Server Application combines the monetary amount with the User ID

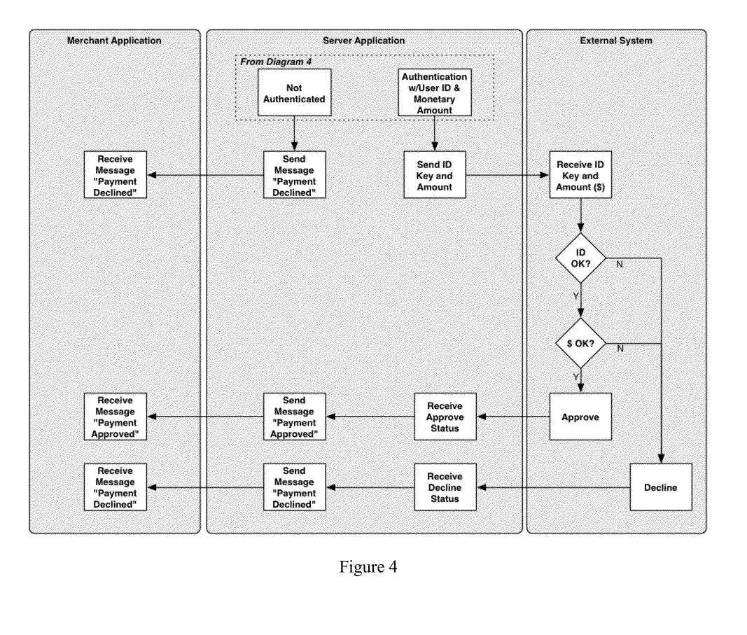

FIG. 4

FIG. 4 illustrates an interface with an external system for final payment authorization. FIG. 4 illustrates the following sequence of operations.
1. If the transaction is authenticated
   a. The Server Application sends the User ID and Monetary amount to the third-party payment processing system
   b. If the User ID and Monetary amount are okay, the Server Application receives approval from the external system
   c. If either the User ID or Monetary amount are not okay, the Server Application receives a denial with an error code indicating which factor was the cause for denial
   d. Upon approval, the Server Application transmits a message to the Merchant Application indicating this fact
   e. Upon denial, the Server Application transmits a message to the Merchant Application indicating this fact
2. If the transaction is not authenticated the Server Application transmits a message to the Merchant Application indicating this fact

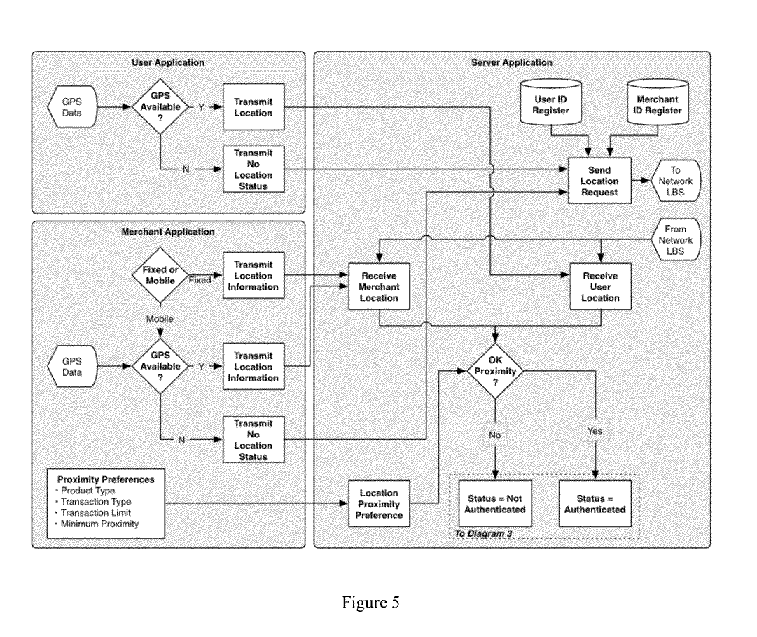

FIG. 5

FIG. 5 illustrates location proximity management involved in determining whether the Server Application should require geographic location as a factor in the authentication of a transaction. The following operation sequence is illustrated in FIG. 5.
1. The User Application will determine if GPS data is available, if so it will transmit that location data. If not, it will send that status to the Server Application
2. If the Merchant Application is fixed, it will transmit location information that has been securely entered into its database. If it is mobile, the Merchant Application will determine if GPS data is available, if so it will transmit that location data. If not, it will send that status to the Server Application
3. If either the User Application or the Merchant Application is unable to determine its location via GPS and transmits this status to the Server Application, the Server Application will use the User and/or Merchant information in its Register to send a location request to the Network LBS API. Receiving a location coordinate response, it will use this information to determine proximity.
4. The Merchant Application will have Proximity Preference settings where the merchant may determine the manner in which the Server Application determines if proximity is okay for an individual transaction.
5. The Server Application compares the location of the User Application and the Merchant Application and calculates the proximity of each utilizing local measurement settings. This information is compared with the Merchant Proximity Preferences to determine if proximity is okay.
6. If the proximity is okay, the Server Application sets this factor to Authenticated. If it is not okay, the factor is set to Not Authenticated.

Additional techniques may be performed with the arrangements described above. For example, the identity and proximity of a mobile user may be determined, for the express purpose of authentication. An arrangement for performing this feature may include the deployment of a micro-component of a radio telecommunications (RF) network, also known as a picocell or femtocell, that is designed specifically for close-range or near-field communications using standard cellular telephone (RF) interface protocols in order to communicate with a user's mobile device for the purpose of identifying that mobile device. Such micro-components comprise external devices of the systems described above. The control system (e.g., at the server application) may enable the adjustment of the femtocell or picocell coverage range for the purpose of clearly defining the range from the picocell or femtocell in which the user will be identified and located. Moreover, such a system provides the ability for an application to consume both user identification and location information provided by a picocell or femtocell and its associated systems for the purpose of authentication and associated application functionality that uses this authentication.

Geographic location of the user can also be accurately determined by the receipt of location information from the cellular network operator, such as the so-called Network-enhanced GPS data. The advantage of this technique is that geographic location can be determined in environments where a GPS signal is not readily available (e.g., inside of buildings). The accuracy of this data is specifically related to the coverage range of the cell site or cell sites that are communicating with the user's mobile phone, which is also typically available as data from the cellular system operator. In the case where a user is communicating with a femtocell, the range of measurement can be as small as one meter in diameter, providing an extremely accurate confirmation of the user's geographic location in proximity to the known location of the merchant, thereby providing an extremely reliable method of authentication.

Once the user's location is accurately determined, the system can notify the user of the availability of information through the generally available notification protocols that are available, including but not limited to, SMS-0. Using this authentication method, the merchant can “push” not only information related to payment processing, but also information related to marketing, sales opportunities, and the like, resulting in so-called “interactive commerce” in real-time between the merchant and the authenticated user. This interaction can usually only occur so long as the session between the merchant application and the user application is maintained with a level of authentication sufficient to ensure that the two are interacting without interruption or intrusion, to fend off possible interception for fraudulent purposes.

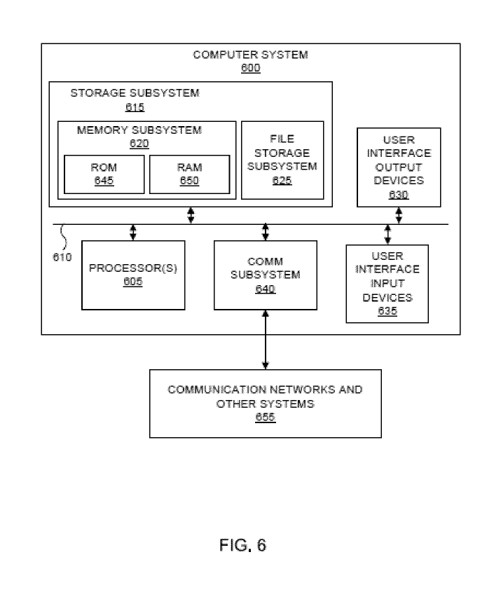

FIG. 6 is a block diagram of a computer system 600 that may incorporate embodiments in accordance with the disclosure for performing the operations described herein, including operations of the authentication system and components such as the authentication server and device at which the various applications such as server, merchant, and user application, are installed. In the present embodiment, the computer system 600 typically includes one or more processors 605, a system bus 610, storage subsystem 615 that includes memory subsystem 620 and file storage subsystem 625, user interface output devices 630, user interface input devices 635, a communications subsystem 640, and the like.

In various embodiments, the computer system 600 typically includes conventional computer components such as the one or more processors 605, and memory storage devices such as a read only memory (ROM) 645 and random access memory (RAM) 650 in the memory subsystem 620, and disk drives in the file storage subsystem 625.

In the illustrated embodiment, the user interface output devices 630 can comprise a variety of devices including computer displays, viewing screens, indicator lights, loudspeakers, tactile output, and the like. The user interface input devices 635 can comprise a variety of devices including a computer mouse, a trackball, a track pad, a joystick, wireless remote, drawing tablet, voice command system, eye tracking system, and the like. The user interface input devices 635 typically allow a user to select objects, icons, text and the like that appear on the user interface output devices 630 via a command such as a click of a button or the like.

Embodiments of the communication subsystem 640 typically include an Ethernet card, a modem (telephone, satellite, cable, ISDN), (asynchronous) digital subscriber line (DSL) unit, FireWire interface, USB interface, and the like. For example, the communications subsystem 640 may be coupled to the communications networks and other systems 655 (e.g., the Internet communications network 60 of FIGS. 4 and 5), to a FireWire bus, or the like. In other embodiments, the communications subsystem 640 be physically integrated on the motherboard of computer system 600, may be a software program, such as soft DSL, or the like.

The RAM 650 and the file storage subsystem 625 are examples of tangible media configured to store data such as payment collection, meter rates, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In the present embodiment, the computer system 600 may also include software that enables communications over a network such as the DNS, TCP/IP, UDP/IP, and HTTP/HTTPS protocols, and the like. In alternative embodiments of the present invention, other communications software and transfer protocols may also be used, for example IPX, or the like.

It will be readily apparent to one of ordinary skill in the art that many other hardware and software configurations are suitable for use with the present invention. For example, the computer system 600 may be a desktop, portable, rack-mounted, or tablet configuration. Additionally, the computer system 600 may be a series of networked computers. Further, the use of other microprocessors are contemplated, such as Pentium™ microprocessors; Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board (e.g., a programmable logic device or graphics processor unit).

The following list of claimed features are enabled by the disclosure provided herein.
1. A multi-factor method of authenticating, the method comprising accessing available user, device, and peripheral information, utilizing the accessed information as one or more components of the multi-factor authentication method, wherein the peripheral information comprises information from an external device.
2. The method of claim 1, wherein the external device that provides the peripheral information comprises, for example, a barcode scanner or a credit card swipe device.
3. The method of claim 1, wherein a transaction relationship is comprised of a user application, a merchant application, and an associated server application, each communicating over a computer network.
4. A user application installed on a mobile device, through which the user application interacts with a host device over a computer network for the purpose of accessing available device and peripheral information.
5. A user application that acts as a user interface for generating a unique software code key (the “App Key”) by a process of a server application that enables the user to enter a text confirmation code (“Unique ID”) that is sent to a mobile device of the user via a network protocol that is solely directed to the mobile device, such as SMS/MMS or by the system delivering this information via a background network protocol (e.g., SMS 0) directly to the application, for the purpose of confirming the device that the network protocol is interfacing with (e.g., MSISDN/Mobile Number related to a specific device). In terms of calculations and/or operations performed by the server to generate the App Key, it is possible to either (a) have the user enter the text confirmation code sent by the server, to confirm the user, or (b) let the system (e.g. a user application) provide the return text confirmation code automatically.
6. A server application that receives specific user information (e.g., User name, mobile number, purchase limit, expiration date, PIN), device information (e.g., IMEI or device serial number), and/or network information (e.g., mobile number, MSISDN), and generates a unique App Key that is securely transmitted to the user application, where it is securely stored in a volatile memory location. The application deletes the App Key upon any attempt to access the App Key or transfer the user application to another device, at which time the user will be required to repeat the confirmation process outlined in claim 4 to generate a new App Key. The server, to generate a new App Key, will use a pseudo-random number generator with a business rule that ensures that each key is unique.
7. A server application that uses the App Key plus other information related to the identity of the user and creates a unique encrypted software code key (the “Authentication Key”). The Authentication Key is a combination of the App Key plus randomly selected user data that has been stored on the Server. This ensures a high level of security by combining the random data that is stored at two different locations. The Authentication Key can be rendered in any form necessary for use by any number of device-to-device transducers including, but not limited to, optical (e.g., infrared, screen/camera) and radio frequency transducers (e.g., WiFi, Bluetooth, Near-field Communications). For optical use, the Authentication Key can be rendered as an encrypted text string across an infrared connection or a displayed optical code (e.g., 2D Barcode) for reading by a camera. For radio frequency transducers, the Authentication Key can be communicated between devices as an encrypted code.
8. In the method as described in claim 1, the user application securely stores a set of Authentication Keys in an encrypted Authentication Key Register for use over a specified time period by the application to utilize during the Authentication process to reduce/eliminate the need for the user application to interact in real-time with the application server (i.e., server application) in case of service/connection interruption. The number of Authentication Keys in the Authentication Key Register will vary based on system preference settings.
9. A method of using the Authentication Key as in claim 8 in a secure authentication process involving two devices with compatible transducer technology using either a purpose built application or as part of another application.
10. The method of claim 9, wherein two devices with transducers communicating in a process using any method ranging from optical to radio frequency, each with proprietary applications designed to interface and communicate with these transducers and then interface and communicate with a common and proprietary server application to create a secure closed-loop process.
11. The method of claim 9, wherein the user accesses the user application and enables the transmission of the Authentication Key. At the moment of transmission, the Authentication Key is combined with the App Key. Per FIG. 3, the user app combines the App Key and Authentication Key to generate a combined or Composed Key. The composed key comprises a simple combination or append function that will combine the two keys together. Access may or may not be protected from access by a PIN. Upon the user triggering access, the user application will look up one of the stored Application Keys in the Application Key Register and utilize it in the authentication process. The parameters used by the user app to look up and find the stored Application Key that is needed for the transaction will be managed in a simple FIFO (first in first out) register method. Once the key is utilized it will be deleted from the register.
12. The method of claim 9, wherein a merchant accesses the merchant application, which may be standalone or a part of another application. The merchant app may comprise an app at a POS terminal, for a face-to-face interactive transaction at a retail store or marketplace to take the place of credit cards and credit card terminals where two devices in close proximity can interact via any device-to-device transducer (e.g., NFC, optical camera/screen). The merchant may be required to enter additional information into the merchant application, including but not limited to, payment amount and merchant PIN. Upon the completion of the entry of any additional required information by the merchant, the merchant application receives the transmission of the Authentication Key. The Composed Key is authenticated by the Server. The Merchant App only checks its validity from a format perspective so that someone can't falsify a QR code or NFC signal or the like. The Composed Key does expire after a preset time period. Upon receipt of the Authentication Key, a PIN code may be entered as an additional authentication factor. The PIN code is entered by the user, either by entering it on a keypad on the Merchant App or on a keypad on the User App. This requirement will be set as a preference by the system administrator and could be related to the amount or type of transaction. This would be most commonly performed using a 10-key keypad. Upon the entry of the PIN code, the Merchant application will authenticate the validity of the Authentication Key using information embedded in the Authentication Key. The User's name is stored in the clear, just as on a credit card. This will be displayed to the merchant in case they want to ask for additional identification (e.g., drivers license). The PIN code is encrypted in the Composed Key so that it can be decrypted by the Merchant App as a first check of its authenticity. This is similar to how a chip-pin card works in the credit card industry. If the Authentication Key is valid, it will be transmitted back to the Server Application for additional authentication along with any other information that is required for the transaction.
13. The method of claim 9, wherein the server application will examine both the Application Key Register and the Authentication Key Register for that user and compare the Application Key and Authentication Key it received with those in the registers. The App Key register may be indexed by User ID, and the Authentication Key register may also be indexed by User ID. If one or both of the keys are determined to be invalid by either the merchant application or the server application, the server application will set the transaction status to Not Authenticated and the merchant application will display an appropriate message indicating its invalidity and will take whatever further action is required in the process. A simple mismatch of any one of the factors from a mismatched App Key, Auth Key, location check and/or PIN will result in a conclusion of invalid App Key or Authentication Key. If both the keys are valid, the Server will set the transaction status to Authenticated for further action.
14. A method to correlate this authentication process to another process or application using an anonymous identifier or “ID Key” as an identification proxy for information that may be best hidden or obscured during the process including, but not limited to, private customer identification data. In this method, an ID Key would be generated by any external system being interface with that would use the authentication to perform a function, such as process a payment. For example, many credit card gateways offer customer data management services where the gateway stores a customer's credit card information rather than the point of sale or eCommerce system that is connecting to it. The gateway provides the POS/eCommerce system with a token that represents that customer's ‘account’ and when a transaction is performed, instead of sending a credit card number and amount, the POS/eCommerce system sends the token and purchase amount. The gateway then correlates this token to the customer's credit card information and processes it.
15. The method of claim 14, wherein the proprietary server application referenced in claim 8 interfaced to a compatible third-party application or system.
16. The method of claim 9, and/or claim 14, wherein, in the case where an ID Key is utilized in the process, this ID Key would be included as part of the Authentication Key to enable the correlation between the Authentication event and the ID associated with it. The ID key would be “included” with the Authentication Key, like every other combination of keys, in one of the aforementioned methods, in a manner that will be apparent to those skilled in the art, in view of the description herein.
17. The method of claim 14, wherein, in the case where a high level of identification security is desired the server application will utilize an anonymous identifier or ID Key from another process, system or application and use this to accurately and securely correlate the authentication to that anonymous identifier completely obscuring the information from the other system during the authentication process. This could be used as a secure method of payment processing without the payer's identification ever being directly involved in the authentication process.
18. A method to utilize location-based services to determine a user application location and relate it to the merchant application location for the purpose of authenticating a transaction between the two applications and utilizes this as an additional method for multi-factor authentication. To assert a real-time location identity (e.g., Seattle) and check that asserted location against GPS data or the like, the Proximity Authentication can be called, where the system compares the location of the User Application and the location of the Merchant Application using the cellular and/or WiFi networks or confirmed manual entry, in the case of a permanently installed merchant POS. When the transaction is performed, the Server will make a call to the cellular providers location-based service API requesting the location of the device on which the User App is registered. The User App can also call the device's GPS, but this is not as secure because the user can turn this feature off, while they cannot turn off the location feature for verification purposes. The same is true for a merchant's app. As long as there is an IP address, the general vicinity can be determined.
19. The method of claim 18, wherein the proprietary user application, merchant application, and server application comprise the features referenced in claim 1.
20. The method of claim 18, wherein the user application accesses the location-based service of the device to determine the location of the device in which the application is installed. This information is related to the server application and compared to the known location of the merchant application, whose location is determined using a similar method. That is, in this aspect, the server app is acting as a “clearinghouse” for geographic locations of both the user and the merchant, to determine proximity. For the purpose of maintaining privacy, the system will never disclose or store the user's location after this calculation is completed.
21. The method of claim 18, further including the ability to define the proximity required between the user application and the merchant application to authenticate a payment using this method, including any known margin of error for the location-based service method utilized to determine the proximity. That is, this aspect relates to an in-person transaction, to ensure via location-based services that the user and the merchant are in the same geographical location. This can also be used to process a transaction (e.g., pay a road toll) by determining that the user has entered an area or location that has fees associated with it (e.g., toll road or a parking lot).

What is claimed is:

1. A multi-factor method of authenticating for user access to a computer system, the method comprising:
accessing available user, device, and peripheral information at a processor of the computer system;
utilizing the accessed information as one or more components of the multi-factor authentication method;
wherein the peripheral information comprises information from an external device.

2. The method of claim 1, wherein the external device that provides the peripheral information comprises either a barcode scanner or a credit card swipe device or both.

3. The method of claim 1, wherein a transaction relationship is comprised of a user application, a merchant application, and an associated server application, each communicating with each other over a computer network.

4. A computer device comprising:
a processor that provides an operating system by which applications may be executed;
a user application that is executable by the operating system;
wherein the user application is installed on a mobile device, through which the user application interacts with a host device over a computer network for the purpose of accessing available device and peripheral information for authenticating user access to a computer system.

5. A computer device comprising:
a processor that provides an operating system by which applications may be executed;
a user application that is executable by the operating system;
wherein the user application provides a user interface for generating a unique software code key (App Key) by a process of a server application that enables the user to enter a text confirmation code (Unique ID) that is sent to the computer device via a network protocol that is solely directed to the user application of the computer device, for the purpose of confirming that the network protocol is interfacing with the computer device, wherein the App Key is generated by either (a) the user entering the text confirmation code sent by the server, to confirm the user, or (b) the computer device providing the return text confirmation code.

6. A computer device comprising:
a processor that provides an operating system by which applications may be executed;
a server application that is executable by the operating system;
wherein the server application receives either one or both of specific user information and/or network information, and generates a unique App Key that is securely transmitted to a user application of a user device that stores the App Key in memory, such that the user application deletes the App Key upon any attempt to access the App Key or transfer the user application to another device, at which time the user is required to repeat a confirmation process and generate a new App Key, and such that the server application generates a new App Key using a pseudo-random number generator that ensures each new App Key is unique.

7. A computer device as in claim 6, wherein the App Key is used by the server application with other information related to the identity of the user to create a unique encrypted software code key (Authentication Key) comprising a combination of the App Key and randomly selected user data that has been stored at the computer device, such that the Authentication Key can be rendered in multiple form for use by multiple types of transducers, including one or more of, but not limited to, optical and radio frequency transducer types.

8. The method as in claim 3, wherein the user application securely stores a set of Authentication Keys in an encrypted Authentication Key Register for use over a specified time period by the authentication method to reduce interaction of the user application with the server application in an interruption of communications.

9. The method as in claim 8, further including a secure authentication process that involves at least two devices with compatible transducer technology and capable of using either a purpose built application or as part of another application to communicate and perform the authentication process.

10. The method as in claim 9, wherein the two devices communicate based on transducer types comprising either or both of optical and radio frequency, each transducer type utilizing a respective proprietary application configured to interface and communicate with these transducer types and then interface and communicate with a server application to create a secure closed-loop process.

11. The method as in claim 9, wherein the user application enables the transmission of the Authentication Key and, wherein the Authentication Key is combined with the App Key by the user application to generate a Composed Key based on the Authentication Key and the App Key, such that the Composed Key comprises a function that combines the two keys together, and wherein upon the user triggering access, the user application will look up one of the stored Application Keys in an Application Key Register and utilize it in the authentication method, and wherein the user application deletes the Application Key after it is utilized.

12. The method as in claim 11, wherein a merchant application at a point-of-sale terminal (POS terminal) receives the Authentication Key and the Composed Key is authenticated by the server application, and wherein the Merchant Application checks validity of the keys only from a format perspective, and wherein the Composed Key expires after a preset time period and, upon receipt of the Authentication Key, a PIN code may be entered as an additional authentication factor such that, upon the entry of the PIN code, the Merchant Application authenticates the validity of the Authentication Key using information embedded in the Authentication Key, and the PIN code is encrypted in the Composed Key so that it can be decrypted by the Merchant Application as a check of its authenticity, such that, if the Authentication Key is valid, it will be transmitted back to the Server Application for additional authentication along with any other information that is required for the transaction.

13. The method as in claim 12, wherein the transaction relates to a user application, a merchant application, and an associated server application, each communicating with each other over a computer network, and wherein the server application examines both the Application Key Register and the Authentication Key Register for the associated user and compares the Application Key and Authentication Key it received with corresponding keys stored in the registers, such that if one or both of the keys are determined to be invalid by either the merchant application or the server application, then the server application will set the transaction status to Not Authenticated and the merchant application will display an appropriate message indicating its invalidity, and if both the keys are valid, the Server will set the transaction status to Authenticated.

14. A method for correlating an authentication process at a computing device to another process using an anonymous identifier (ID Key) as an identification proxy for information including, but not limited to, private customer identification data, the method comprising:
receiving an ID Key from an external device for a customer;
determining a token that represents an account of the customer;
sending the token and a purchase amount, in response to performance of a transaction, to a sales system that correlates the token to the customer credit card information and processes the transaction.

15. The method as in claim 14, wherein the transaction relates to a user application, a merchant application, and an associated server application, each communicating with each other over a computer network, and wherein the server application communicates with an external application.

16. The method as in claim 14, wherein, in the case where an ID Key is utilized in the process, the ID Key is included as part of the Authentication Key and enables correlation between the Authentication event and the ID associated with it.

17. The method of claim 14, wherein the server application utilizes an anonymous identifier (ID Key) from an external application to correlate the authentication to that anonymous identifier so as to completely obscure the information from the external application during the authentication process.

18. A method for authenticating a transaction between the two applications in a transaction system, the method comprising:
performing a multi-factor authentication that utilizes location-based services to determine a user application location for a user device and relate it to a merchant application location;
checking a real-time location identity of the merchant location against an asserted location using a Proximity Authentication process, wherein the transaction system compares the location of a User Application and the location of the Merchant Application such that, when the transaction is performed, a Transaction System Server makes a call to a location-based service API requesting the location of the user device on which the User App is registered.

19. The method as in claim 18, further including performing a multi-factor authentication process that accesses available user, device, and peripheral information and utilizes the accessed information, wherein the peripheral information comprises information from an external device.

20. The method as in claim 19, wherein the user application accesses the location-based service of the device to determine the location of the device in which the application is installed and compares the information to a known location of the merchant application, without storing the user's location after the location is determined.

21. The method as in claim 19, wherein the proximity required between the user application and the merchant application to authenticate a payment is determined in accordance with a predetermined margin of error for the location-based service method, to ensure via location-based services that the user and the merchant are in the same geographical location.
